(19) United States
(12) Patent Application Publication
(10) Pub. No.: US 2025/0142620 A1
(43) Pub. Date: May 1, 2025

(54) ACCESS POINT MULTI-LINK DEVICE ALLOCATION

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 18/933,976

(22) Filed: Oct. 31, 2024

Related U.S. Application Data
(60) Provisional application No. 63/595,293, filed on Nov. 1, 2023.
(60) Provisional application No. 63/699,579, filed on Sep. 26, 2024.

(30) Foreign Application Priority Data
Oct. 25, 2024 (CN) 202411503972.2

(51) Int. Cl. H04W 74/0816; H04B 17/309; H04W 8/22; H04W 80/02

(52) U.S. Cl. CPC H04W 74/0816; H04B 17/346; H04W 8/22; H04W 80/02

(57) ABSTRACT

An access point (AP) multi-link device (MLD) for facilitating wireless communication in a wireless network, the AP MLD device comprising processing circuitry configured to transmit, to a station (STA) affiliated with a non-AP MLD, a first frame that includes a request for operational information from the STA, wherein the STA is operating on a first link, receive, from the STA, a second frame that includes a response to the request for the operational information, determine to allocate a second link to STA based on the response to the request for the operational information, and transmit, to the STA, a third frame that includes a link allocation recommendation that allocates the second link to the STA.

### CROSS-REFERENCE TO RELATED APPLICATIONS

This application claims benefit of U.S. Provisional Application No. 63/595,293, filed on Nov. 1, 2023, and U.S. Provisional Application No. 63/699,579, filed on Sep. 26, 2024, in the United States Patent and Trademark Office, and China Patent Application No. 202411503972.2, filed on Oct. 25, 2024, in the China National Intellectual Property Administration, the entire contents of which are hereby incorporated by reference.

### TECHNICAL FIELD

The disclosure relates generally to wireless communication, and more particularly to, for example, but not limited to, multi-link device link allocation in wireless network.

### BACKGROUND

Wireless local area network (WLAN) devices are widely deployed in diverse environments to provide various communication services such as video, cloud access, broadcasting and offloading. Some of these environments have a lot of access points (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

However, there is a general need for improved WLAN to support real-time applications or delay-sensitive applications that require strict requirements on the delay and packet loss ratio. These applications include online gaming, real-time video streaming, virtual reality, and remote-control drones and vehicles.

The description set forth in the background section should not be assumed to be prior art merely because it is set forth in the background section. The background section may describe aspects or embodiments of the present disclosure.

### SUMMARY

One aspect of the present disclosure provides an access point (AP) multi-link device (MLD) for facilitating wireless communication in a wireless network. The AP MLD device comprises processing circuitry. The processing circuitry is configured to transmit, to a station (STA) affiliated with a non-AP MLD, a first frame that includes a request for operational information from the STA, wherein the STA is operating on a first link. The processing circuitry is configured to receive, from the STA, a second frame that includes a response to the request for the operational information. The processing circuitry is configured to determine to allocate a second link to STA based on the response to the request for the operational information. The processing circuitry is configured to transmit, to the STA, a third frame that includes a link allocation recommendation that allocates the second link to the STA.

In some embodiments, the response to the request for the operational information indicates that a number of STAs operating on the first link are larger than a first threshold, an amount of traffic accumulated in a buffer of an STA among one or more STAs operating on the first link is larger than a second threshold, or the STA is located near a coverage edge or has a signal-to-noise ratio below a third threshold.

In some embodiments, the request for the operational information is included in a medium access control (MAC) frame of the first frame, and the response to the request for operational information is included in a MAC frame of the second frame.

In some embodiments the request for the operational information is included in a control field of the first frame, and the response to the request for the operational information is included in a control field of the second frame.

In some embodiments, the first frame is a request to send (RTS) frame that includes the request for the operational information, and the second frame is a clear to send (CTS) frame that includes the response to the request for the operational information.

In some embodiments, the processing circuitry is further configured to receive a fourth frame from the STA that includes capability information associated with links or operating bands supported by the STA, and determine the link allocation recommendation based on the capability information.

In some embodiments, the second frame includes a signal to interference and noise ratio (SINR) or a buffer status of the STA.

One aspect of the present disclosure provides a station (STA) associated with a non-access point (AP) multi-link device (MLD) for connecting to a wireless network, comprising processing circuitry. The processing circuitry is configured to receive, from a first AP affiliated with an AP MLD, a first frame that includes a request for operational information, wherein the STA is operating on a first link. The processing circuitry is configured to transmit, to the first AP, a second frame that includes a response to the request for the operational information. The processing circuitry is configured to receive, from the first AP, a third frame that includes a link allocation recommendation that allocates a second link to the STA, wherein a second AP affiliated with the AP MLD operates on the second link. The processing circuitry is configured to initiate communication with the second AP on the second link based on the link allocation recommendation.

In some embodiments, the response to the request for the operational information indicates that a number of STAs operating on the first link are larger than a first threshold, an amount of traffic accumulated in a buffer of an STA among one or more STAs operating on the first link is larger than a second threshold, or the STA is located near a coverage edge or has a signal-to-noise ratio below a third threshold.

In some embodiments, the request for the operational information is included in a medium access control (MAC) frame of the first frame, and the response to the request for the operational information is included in a MAC frame of the second frame.

In some embodiments, the request for the operational information is included in a control field of the first frame, and the response to the request for the operational information is included in a control field of the second frame.

In some embodiments, the first frame is a request to send (RTS) frame that includes the request for the operational information, and the second frame is a clear to send (CTS) frame that includes the response to the request for the operational information.

In some embodiments, the processing circuitry is further configured to transmit, to the first AP, a fourth frame that includes capability information.

In some embodiments, the second frame includes a signal to interference and noise ratio (SINR) or a buffer status of the STA.

One aspect of the present disclosure provides a computer-implemented method by an access point (AP) multi-link device (MLD) for facilitating wireless communication in a wireless network by. The method comprises transmitting, to a station (STA) affiliated with a non-AP MLD, a first frame that includes a request for operational information from the STA, wherein the STA is operating on a first link. The method comprises receiving, from the STA, a second frame that includes a response to the request for the operational information. The method comprises determining to allocate a second link to STA based on the response to the request for the operational information. The method comprises transmitting, to the STA, a third frame that includes a link allocation recommendation that allocates the second link to the STA.

In some embodiments, the operational information indicates that a number of STAs operating on the first link are larger than a first threshold, an amount of traffic accumulated in a buffer of an STA among one or more STAs operating on the first link is larger than a second threshold, or the STA is located near a coverage edge or has a signal-to-noise ratio below a third threshold.

In some embodiments, the request for the operational information is included in a medium access control (MAC) frame of the first frame, and the response to the request for the operational information is included in a MAC frame of the second frame.

In some embodiments, the request for the operational information is included in a control field of the first frame, and the response to the request for the operational information is included in a control field of the second frame.

In some embodiments, the first frame is a request to send (RTS) frame that includes the request for the operational information, and the second frame is a clear to send (CTS) frame that includes the response to the request for the operational information.

In some embodiments, the method further comprises receiving a fourth frame that includes capability information from the STA, and determining the link allocation recommendation based on the capability information.

### BRIEF DESCRIPTION OF THE DRAWINGS

FIG. 1 illustrates an example of a wireless communication network in accordance with an embodiment.

FIG. 2 illustrates an example of a timing diagram of interframe space (IFS) relationships between wireless devices in accordance with an embodiment.

FIG. 3 illustrates examples of OFDM symbols and OFDMA symbols in accordance with an embodiment.

FIG. 4A illustrates an example of PPDU format in accordance with an embodiment. The PPDU may be used for SU and MU transmission.

FIG. 4B illustrates another example of PPDU format in accordance with an embodiment.

FIG. 5 illustrates a schematic diagram of an example of an electronic device in accordance with an embodiment.

FIG. 6 illustrates a schematic diagram of an example of a transmitter in accordance with an embodiment.

FIG. 7 illustrates a schematic diagram of an example of a receiver in accordance with an embodiment.

FIG. 8 illustrates MLO operations with two links in accordance with an embodiment.

FIG. 9 illustrates an example topology of an AP MLD and associated STAs in accordance with an embodiment.

FIG. 10 illustrates an example communication between a STA and an AP MLD to exchange capability information in accordance with an embodiment.

FIG. 11 illustrates an example exchange of link information by a link information request frame and a link information response frame in accordance with an embodiment.

FIG. 12 illustrates exchanging link information during data transmission in accordance with an embodiment.

FIG. 13 illustrates communicating link information in control frames in accordance with an embodiment.

FIG. 14 illustrates an AP MLD providing a link allocation recommendation to a STA in accordance with an embodiment.

FIG. 15 illustrates a STA operating on a different link based on a link allocation recommendation from an AP MLD in accordance with an embodiment.

FIG. 16 illustrates a flow chart of an example process of an AP allocating links in accordance with an embodiment.

FIG. 17 illustrates a flow chart of an example process of a STA configuring links based on a recommendation in accordance with an embodiment.

### DETAILED DESCRIPTION

The detailed description provided below is intended to describe various implementations and is not intended to represent the sole implementation. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description below has been described with reference to a WLAN system based on the Institute of Electrical and Electronics Engineers (IEEE) 802.11 wireless standards, including the current and future amendments. However, a person having ordinary skill in the art will readily recognize that the teachings herein are applicable to other network environments, such as cellular telecommunication networks and wired telecommunication networks.

In some embodiments, apparatuses or devices such as an AP station and a non-AP station may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. Additionally, the apparatus may include one or more other hardware or software elements such as a network interface and a display device.

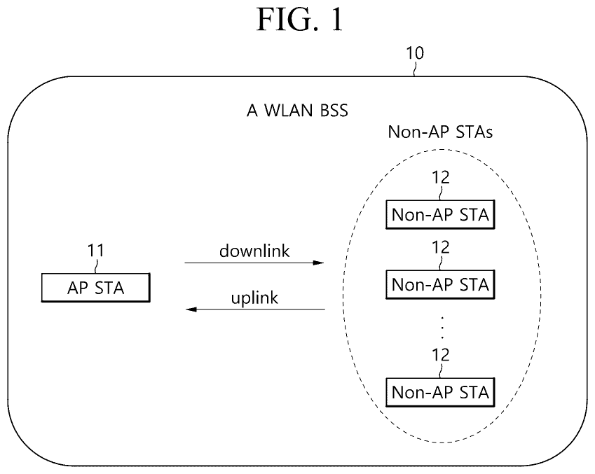

FIG. 1 illustrates an example of a wireless communication network in accordance with an embodiment. The wireless communication network may include a Basic Service Set (BSS) 10. The BSS 10 provides the basic organizational unit and includes a plurality of wireless devices which may be referred to as stations (STAs). In some implementations, the wireless device may include a plurality of STAs inside. The STA maybe a logical entity that is a singly addressable instance of a medium access control (MAC) and physical layer (PHY) interface to the wireless medium (WM) according to IEEE 802.11 standards. The STA may be an access point (AP) STA and a non-AP STA. The AP STA may be an entity that contains one STA and provides access to the distribution system services via the wireless medium for associated STAs. The non-AP STA may be a STA that is not contained within an AP STA. The AP STA and the non-AP STA may be collectively called an STA. For simplicity of description, an AP STA may be referred to as an AP and a non-AP STA may be referred to as a STA or a station. The AP STA may comprise, be implemented as, or be included in a wireless device such as a centralized controller, a base station (BS), a node-B, a base transceiver system (BTS), a site controller, a network adapter, and a router. Similarly, the non-AP STA may comprise, be implemented as, or be included in a wireless communication device such as a terminal, a wireless transmit/receive unit (WTRU), a user equipment (UE), a mobile station (MS), a mobile terminal, a mobile subscriber unit, a laptop, a smartphone, a battery pack, and a non-mobile computing device.

Referring to FIG. 1, the BSS 10 in the wireless communication network may include an AP STA 11 and a plurality of non-AP STAs 12. The AP STA 11 may transmit information to a single station among the non-AP STAs 12 or may simultaneously transmit information to two or more stations among the non-AP STAs 12. The AP STA 11 may use, for the simultaneous transmission, Downlink (DL) multi-user (MU) transmission scheme such as DL OFDMA (Orthogonal Frequency Division Multiplexing Access) and DL MU-MIMO (Multi-User Multi-Input-Multi-Output). Similarly, each of the non-AP STAs 12 may individually transmit information to an AP STA or may simultaneously transmit information along with one or more other non-AP STAs 12. The non-AP STAs 12 may use, for the simultaneous transmission, Uplink (UL) MU transmission scheme such as UL OFDMA and UL MU-MIMO. In MU-MIMO transmission, a transmitting station may simultaneously transmit information to a plurality of receiving stations using one or more antennas over the same subcarriers. Different spatial streams may be used as the different resources in the MU-MIMO transmission. In OFDMA transmission, a transmitting station may simultaneously transmit information to a plurality of receiving stations over different groups of subcarriers. Different frequency (subcarriers) may be used as the different resource in the OFDMA transmission.

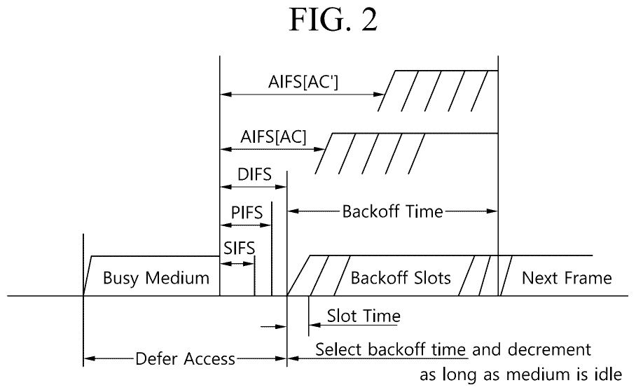

FIG. 2 illustrates an example of a timing diagram of interframe space (IFS) relationships between wireless devices in accordance with an embodiment. FIG. 2 depicts a CSMA (carrier sense multiple access)/CA (collision avoidance) frame transmission procedure to prevent collision between frames on a channel. These frames may include a data frame, a control frame, or a management frame that are exchanged among wireless devices.

The data frame may be used for transmission of data forwarded to a higher layer in a receiving station. In FIG. 2, access to the medium by wireless devices is deferred while the medium is busy until an IFS duration has elapsed. For example, a wireless device may transmit a data frame after completing a backoff period when a Distributed Coordination Function (DCF) IFS (DIFS) has expired. The management frame may be used for exchanging management information which is not forwarded to the higher layer in a receiving station. The management frame includes a beacon frame, an association request/response frame, disassociation frame, reassociation request/response frame, a probe request/response frame, and an authentication request/response frame and action frame. The control frame may be used for controlling access to the medium. The control frame includes a request to send (RTS) frame, a clear to send (CTS) frame, and an acknowledgment (ACK) frame, BlockAck request/response frame, NDP (Null Data PPDU) Announcement frame. If the control frame is not a response frame to another frame, the wireless device may transmit the control frame after performing backoff operation when the DIFS has elapsed. However, if the control frame is a response frame to another frame, the wireless device may transmit the control frame without performing backoff operation when a short IFS (SIFS) has elapsed. Furthermore, a QoS (Quality of Service) STA may transmit a frame after performing backoff operation when an arbitration IFS (AIFS) for access category (AC) (i.e., AIFS [AC]) has elapsed. In some embodiments, a point coordination function (PCF) enabled AP STA may transmit the frame after performing backoff operation when a PCF IFS (PIFS) has elapsed. The PIFS duration may be less than the DIFS duration, but greater than the SIFS duration.

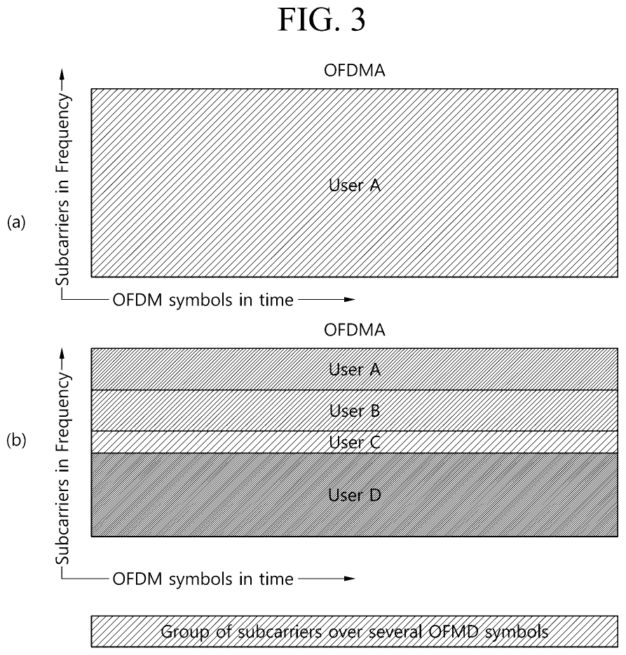

FIG. 3 illustrates examples of OFDM symbols and OFDMA symbols in accordance with an embodiment. In FIGS. 3(a) and 3(b), OFDM/OFDMA symbols are illustrated along the time dimension and subcarriers are illustrated along the frequency dimension.

The OFDMA was introduced in IEEE 802.11ax standard which is also known as High Efficiency (HE) WLAN. The OFDMA will be also used in next amendments to IEEE 802.11 standard such as Extreme High Throughput (EHT) WLAN. One or more STAs may be allowed to use one or more resource units (RUs) throughout operating bandwidth to transmit data at the same time. The RU may be a group of subcarriers as an allocation for subcarriers for transmission. In some aspects, non-AP STAs may be associated or non-associated with AP STA when transmitting response frames simultaneously in assigned RUs after a specific period of time such as SIFS. The SIFS may be the time from the end of the last symbol, or signal extension if present, of the previous frame to the beginning of the first symbol of the preamble of the subsequent frame.

The OFDMA is an OFDM-based multiple access scheme where different groups of subcarriers are allocated to different users, which allows simultaneous transmission to one or more users with high accurate synchronization for frequency orthogonality. The OFDMA allows users to be allocated to different groups of subcarriers in each PPDU (physical layer protocol data unit). An OFDM symbol in the OFDMA may include a plurality of subcarriers depending on the bandwidth of the PPDU. The difference between OFDM and OFDMA is illustrated in FIG. 3. As shown in FIG. 3(a), the OFDM symbol includes one single user (User A), while the OFDMA symbol includes a plurality of users (User A, User B, User C, and User D) and each user is assigned and allocated into different group of subcarriers as shown in FIG. 3(b).

In the case of UL MU transmission, the AP STA may control the medium by using more scheduled access mechanism which allows AP STAs and non-AP STAs to use OFDMA and MU-MIMO. A UL MU PPDU may be sent by non-AP STAs as a response to a trigger frame sent by the AP STA. The trigger frame may have information for receiving STAs and assign a single or multiple RU to the receiving STAs. It allows non-AP STAs to transmit OFDMA-based frame in the form of trigger-based (TB) PPDU (e.g., HE TB PPDU or EHT TB PPDU) where an operating bandwidth is segmented into a plurality of RUs and each RU serves as responses to the trigger frame. For simplicity of description, a single RU and a multiple RU (MRU) which are allocated into a non-AP STA may be collectively referred to as an RU. In some embodiments, the MRU may indicate the combination of two RUs.

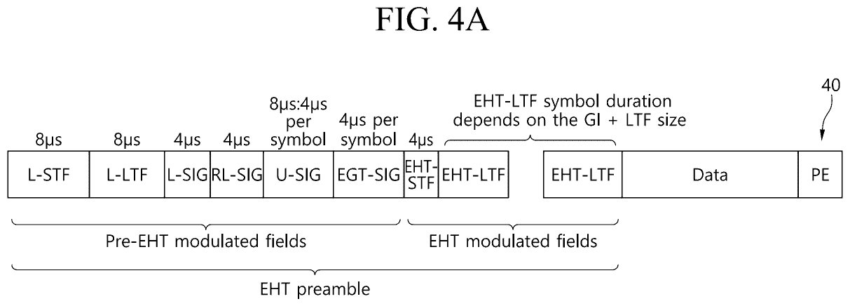

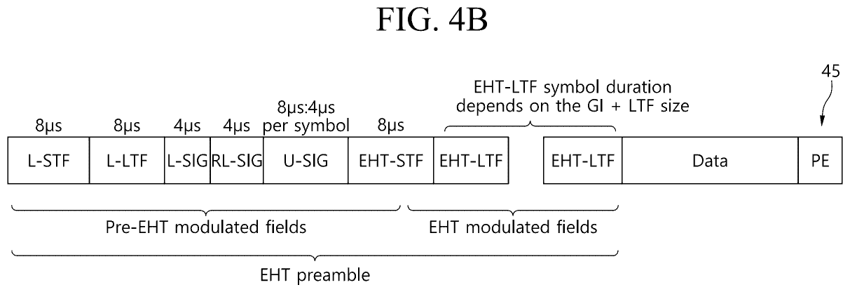

FIG. 4A illustrates an example of PPDU format in accordance with an embodiment. The PPDU may be used for SU and MU transmission. The PPDU may be used as EHT MU PPDU in accordance with IEEE 802.11be or may be used as a PPDU in accordance with any future amendments to the IEEE 802.11 standard.

Referring to FIG. 4A, the EHT MU PPDU 40 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a legacy short training field (L-STF), a legacy long training field (L-LTF), a legacy signal (L-SIG) field, a repeated legacy signal (RL-SIG) field, a universal signal (U-SIG) field and a EHT signal (EHT-SIG) field. The EHT modulated fields may include an EHT short training field (EHT-STF) and one or more EHT long training fields (EHT-LTFs).

The L-STF may be utilized for packet detection, automatic gain control (AGC) and coarse frequency-offset correction. The L-LTF may be utilized for channel estimation, fine frequency-offset correction, and symbol timing. The L-SIG field may provide information for communication such as data rate, a length related to the EHT PPDU 40. The RL-SIG field may be a repeat of the L-SIG field and may be used to differentiate an EHT PPDU from other PPDUs conforming to other IEEE 802.11 standards such as IEEE 802.11a/n/ac. The U-SIG field may provide information necessary for receiving STAs to interpret the EHT MU PPDU. The EHT-SIG may provide additional information to the U-SIG field for receiving STAs to interpret the EHT MU PPDU 40. For simplicity of description, the U-SIG field, the EHT-SIG field or both may be referred to herein as the SIG field. EHT-LTFs may enable receiving STAs to estimate the MIMO channel between a set of constellation mapper output and the receive chains. The data field may carry one or more PHY service data units (PSDUs). The PE field may provide additional receive processing time at the end of the EHT MU PPDU.

FIG. 4B illustrates another example of PPDU format in accordance with an embodiment. The PPDU in FIG. 4B may be used for SU and MU transmission. The PPDU 45 may be used as EHT TB (Trigger-based) PPDU in accordance with IEEE 802.11be or may be used as a PPDU conforming to any of future amendments to the IEEE 802.11 standard. In some embodiments, the EHT TB PPDU 45 is used for transmission by non-AP STA that is a response to a triggering frame from an AP STA.

As shown in FIG. 4B, the EHT TB PPDU 45 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a L-STF field, a L-LTF field, a L-SIG field, a RL-SIG field, a U-SIG field. The EHT modulated fields may include an EHT-STF and one or more EHT-LTFs. Unlike the EHT MU PPDU 40, the EHT-SIG may not be present in the EHT TB PPDU 45. Instead, the duration (8 us) of the EHT-STF of the EHT TB PPDU 45 may be twice the duration (4 us) of the EHT-STF of the EHT MU PPDU 40. Detailed description for the other fields in the EHT TB PPDU 45 will be omitted since the description for each field in the EHT MU PPDU 40 can be applied to each corresponding field of the EHT TB PPDU 45.

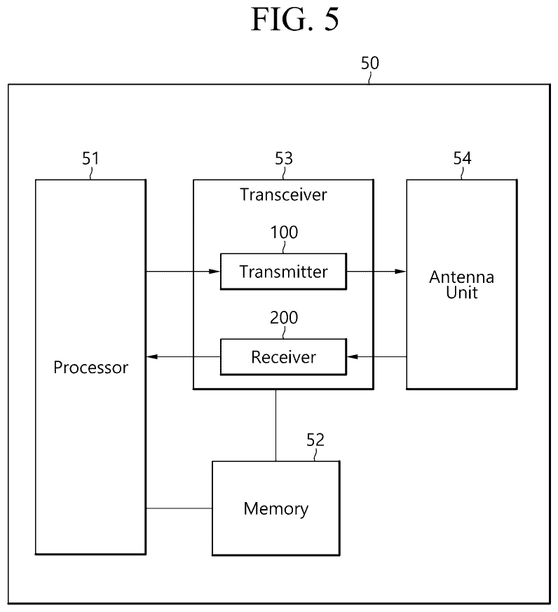

FIG. 5 illustrates a schematic diagram of an example of an electronic device in accordance with an embodiment. The electronic device 50 may be an example of the AP STA 11 or non-AP STA 12 shown in FIG. 1.

Referring to FIG. 5, the electronic device 50 may include a processor 51, a memory 52, a transceiver 53, and an antenna unit 54. The transceiver 53 may include a transmitter 100 and a receiver 200.

The processor 51 may perform medium access control (MAC) functions, PHY functions, RF functions, or a combination of some or all of the foregoing. In some embodiments, the processor 51 may comprise some or all of a transmitter 100 and a receiver 200. The processor 51 may be directly or indirectly coupled to the memory 52. In some embodiments, the processor 51 may include one or more processors.

The memory 52 may be non-transitory computer-readable recording medium storing instructions that, when executed by the processor 51, cause the electronic device 50 to perform operations, methods or procedures set forth in the present disclosure. In some embodiments, the memory 52 may store instructions that are needed by one or more of the processor 51, the transceiver 53, and other components of the electronic device 50. The memory may further store an operating system and applications. The memory 52 may comprise, be implemented as, or be included in a read-and-write memory, a read-only memory, a volatile memory, a non-volatile memory, or a combination of some or all of the foregoing.

The antenna unit 54 includes one or more physical antennas. When MIMO or MU-MIMO is used, the antenna unit 54 may include more than one physical antenna.

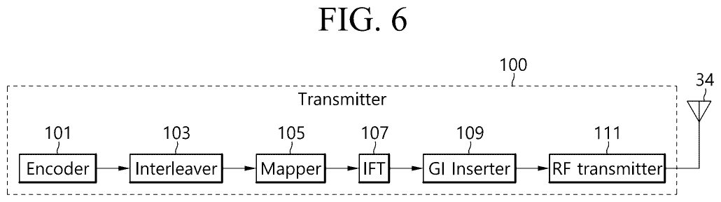

FIG. 6 illustrates a schematic diagram of an example of a transmitter in accordance with an embodiment. The transmitter in FIG. 6 may be an example of the transmitter illustrated in FIG. 5.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder. The interleaver 103 may interleave bits of encoded data from the encoder 101 to change the order of bits, and output interleaved data. In some embodiments, interleaving may be applied when BCC encoding is employed. The mapper 105 may map interleaved data into constellation points to generate a block of constellation points. If the LDPC encoding is used in the encoder 101, the mapper 105 may further perform LDPC tone mapping instead of the constellation mapping. The IFT 107 may convert the block of constellation points into a time domain block corresponding to a symbol by using an inverse discrete Fourier transform (IDFT) or an inverse fast Fourier transform (IFFT). The GI inserter 109 may prepend a GI to the symbol. The RF transmitter 111 may convert the symbols into an RF signal and transmits the RF signal via the antenna unit 34.

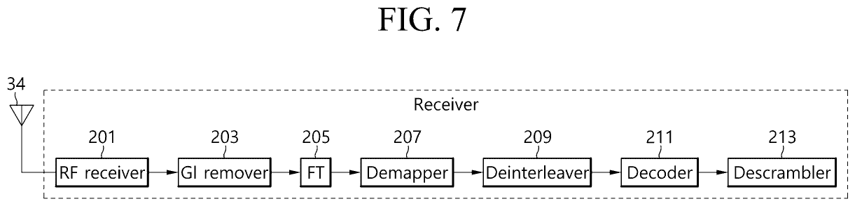

FIG. 7 illustrates a schematic diagram of an example of a receiver in accordance with an embodiment. The receiver in FIG. 7 may be an example of the receiver illustrated in FIG. 5.

Referring to FIG. 7, the receiver 200 in accordance with an embodiment may include a RF receiver 201, a GI remover 203, a Fourier transformer (FT) 205, a demapper 207, a deinterleaver 209, and a decoder 211. The RF receiver 201 may receive an RF signal via the antenna unit 34 and converts the RF signal into one or more symbols. The GI remover 203 may remove the GI from the symbol. The FT 205 may convert the symbol corresponding to a time domain block into a block of constellation points by using a discrete Fourier transform (DFT) or a fast Fourier transform (FFT) depending on implementation. The demapper 207 may demap the block of constellation points to demapped data bits. If the LDPC encoding is used, the demapper 207 may further perform LDPC tone demapping before the constellation demapping. The deinterleaver 209 may deinterleave demapped data bits to generate deinterleaved data bits. In some embodiments, deinterleaving may be applied when BCC encoding is used. The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data. The descrambler 213 may descramble the descrambled data bits based on a scrambler seed.

Multi-Link Operation (MLO) is a feature of next generation WLAN systems. As many multi-link devices (MLDs) incorporate dual-band, tri-band, or more capabilities, MLO may enable packet-level link aggregation in the MAC layer across different PHY links. In some embodiments, an MLD may perform load balancing according to traffic requirements, and thus the MLO may achieve significantly higher throughput, lower latency, and enhanced reliability compared to single link configurations in a heavily loaded network.

With MLO, an MLD may include multiple “affiliated” devices communicating with an upper logical link control (LLC) layer, which may allow concurrent data transmission and reception in multiple channels across a single or multiple frequency bands (e.g., in 2.4 GHz, 5 GHz and 6 GHz, among others).

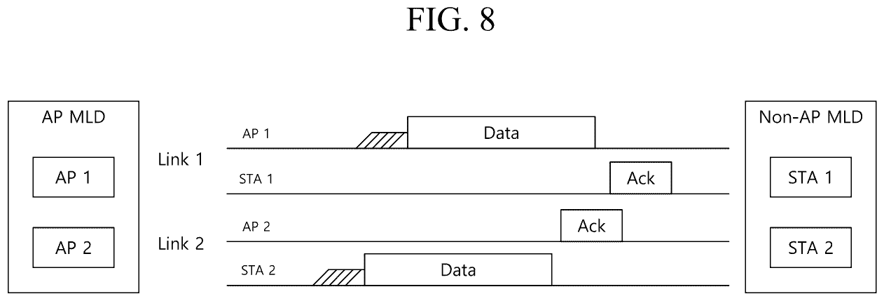

FIG. 8 illustrates an MLO operation with two links in accordance with an embodiment. As illustrated, AP1 and AP2 are affiliated with AP MLD. STA1 and STA2 are affiliated with non-AP MLD. AP1 is associated with STA 1 on link 1. AP2 is associated with STA2 on link 2. AP1 may transmit data to STAI on link 1 and STA1 may transmit an acknowledgement (ACK) frame to AP1. STA2 may transmit data to AP2 on link 2 and AP2 may transmit an ACK frame to STA2.

Existing wireless devices that connect to a single link may be capable of switching to different frequency bands, including 2.4 GHz, 5 GHz and 6 GHz, among other bands. However, these devices typically experience a switching overhead or delay (e.g., of up to 100 ms or more) when switching between the different frequency bands. Accordingly, MLO may be highly desirable for latency-sensitive applications, including real-time applications such as video conferencing, applications that utilize wireless VR headsets, cloud gaming applications, among others.

The IEEE 802.11be standard defines certain channel access protocols for MLD communications. The protocols may include different transmission modes for transmitting frames on links, including an asynchronous mode and a synchronous mode. Under the asynchronous transmission mode, a MLD transmits frames asynchronously across multiple links without aligning at the starting time. In the synchronous transmission mode, the starting time for transmitting frames by the MLD is aligned across the multiple links. In either mode, the links can have their own primary channel and associated link parameters. The link parameters may include various parameters, including parameters related to a Physical Layer Protocol Data Unit (PPDU), a Modulation and Coding Scheme (MCS) parameters, an Enhanced Distributed Channel Access (EDCA) parameters, among other parameters.

As described herein, MLO may allow data traffic to be sent and received simultaneously through different bands and links, which may provide higher transmission rates, reduced latency, and improve network connectivity, among other benefits. However, in order to maximize the benefits of MLO, efficient link allocation may be needed in order to optimize the communication across the different links of the MLO. In some embodiments, a link allocation may consider various characteristics of the links within the MLO, including the number of STAs connected to each link, the amount of traffic to be transmitted on each link, among other factors.

In some embodiments, an AP MLD may identify that a particular link may be suitable for a STA to achieve improved transmission rate, and thus may allocate the link to the STA such that the STA may operate on that link. Efficient link allocation may be beneficial as certain legacy devices may be able to only support a single link and thus these devices may have fewer opportunities to acquire channels compared to MLD devices that may have more opportunities for channel access. Accordingly, embodiments in accordance with this disclosure provide techniques for improving transmission rates of MLO and improving network stability through efficient link allocation that takes into consideration the operational characteristics of the links within a network and associated STAs operating on the links. In some embodiments, an AP MLD may establish a basis service set (BSS) by associating with STAs or STA MLDs for each link supported by AP MLD.

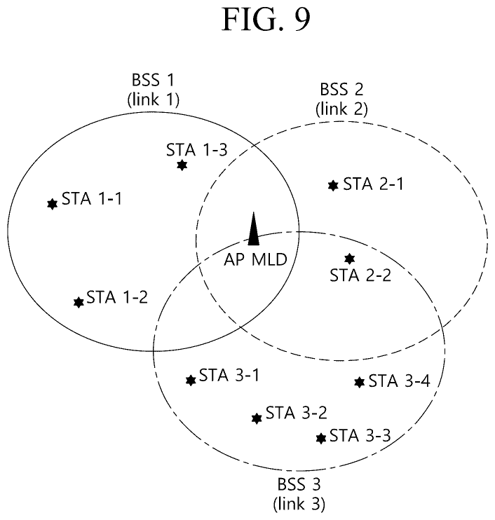

FIG. 9 illustrates an example topology of an AP MLD and associated STAs in accordance with an embodiment. As illustrated, AP MLD has the capability to operate on three or more links and may be affiliated with several APs operating on different frequency bands, including AP1 operating on link 1, AP2 operating on link 2, and AP3 operating on link 3. For example, link 1 uses the 2.4 GHz band, link 2 uses the 5 GHz band, and link 3 uses the 6 GHz band. As illustrated, STA 1-1, STA 1-2 and STA 1-3 may be associated with AP1 of the AP MLD. STA 2-1 and STA 2-2 may be associated with AP2 of AP MLD. STA 3-1, STA 3-2, STA 3-3 and STA 3-4 may be associated with AP3 of AP MLD. STA 1-1, STA 1-2, and STA 1-3 may establish a basic service set (BSS) 1 by associating with AP1 on link1. STA 2-1 and STA 2-2 may establish an association with AP2 on link 2 and form BSS 2. STA 3-1, STA 3-2, and STA 3-3 may establish an association with AP3 on link 3 and form BSS 3.

In some embodiments, the number of links supported by the AP MLD may be greater than the number of links supported by a STA MLD. In some embodiments, a STA may be replaced by a STA MLD with fewer links supported than the AP MLD.

An AP MLD can recommend or instruct one or more STAs to change or reconfigure one or more links on which the STAs operate. In some embodiments, the AP MLD can periodically transmit a reconfiguration request based on network conditions. In certain embodiments, the AP MLD may transmit the reconfiguration request at any time based on the operational characteristics of the network traffic for one or more STAs operating on the one or more links. For example, the AP MLD may transmit a reconfiguration request when a STA on a particular link experiences a particular threshold level of signal to interference and noise ratio (SINR) and/or based on a buffer status of a STA on a link.

As described herein, link allocation may refer to when an AP MLD reconfigures one or more links on which one or more STAs are operating based on the operating conditions of the one or more links. In some embodiments, a STA and/or link(s) to be the target of a link allocation can be based on a variety of factors. In some embodiments, links can be allocated based on a level of competition between STAs for channel acquisition. In particular, if there are a large number of STAs operating on a particular link, it may be difficult for a STA to quickly acquire a channel to transmit data accumulated in a buffer, which may lead to delay problems for the STA. Likewise, even if a number of STAs operating on a particular link is a minimal, if an amount of traffic accumulated in a buffer of a particular STA is large, the time that the particular STA occupies the channel may be too long, which can lead to delay problems for the other STAs on the link as the other STA's channel occupancy time may be reduced.

In some embodiments, if a STA is physically located far from an AP MLD and/or located at a coverage edge of a BSS, the STA may experience a low SINR and thus may have a high probability of transmission failure in communication with AP MLD. Accordingly, reconfiguring the link allocation for the STA to a different link to increase transmission efficiency may improve the overall performance of the total BSS established by AP MLD.

In some embodiments, an AP MLD and a STA may exchange capability information with each other. In some embodiments, a STA associated with an AP MLD may inform the AP MLD about the links and/or operating bands (e.g., 2.4 GHz, 5 GHZ, or 6 GHZ) supported by the STA. In some embodiments, the STA may transmit an association request frame, probe request frame and/or other management frame that may include information regarding the supported links and/operating bands of the STA.

In some embodiments, an AP MLD may inform the STA about links and/or bands which are supported by AP MLD (e.g., link 1 for 2.4 GHz, link 2 for 5 GHz, link 3 for 6 GHz, among others). The AP MLD may transmit an association response frame, probe response frame and/or other management frame that may include the information regarding the supported links and operating bands. Accordingly, the AP MLD may determine the capabilities of a STA, including the links and/or bands on which the STA is capable of operating, in order to efficiently allocate a link to the STA.

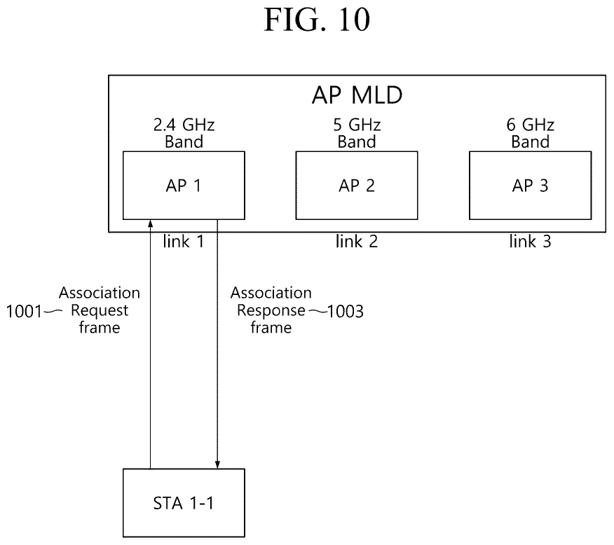

FIG. 10 illustrates an example communication between a STA and an AP MLD to exchange capability information in accordance with an embodiment. As illustrated, AP1, AP2 and AP3 are affiliated with AP MLD. AP1 is associated with STA1-1 on link 1 and operates on a 2.4 GHz band. AP2 operates on link 2 at 5 GHz band. AP3 operates on link 3 at a 6 GHz band. STA1-1 transmits an Association Request frame 1001 to AP1 on link 1. The Association Request frame may include information about the operating bands (e.g., 2.4 GHz, 5 GHz, or 6 GHz, among others) supported by STA1-1.

AP1 transmits an Association Response frame 1003 to STA1-1 on link 1. The Association Response frame 1003 may include information about the links and/or bands supported by the AP MLD, including Link 1 for 2.4 GHz, link 2 for 5 GHz, or link 3 for 6 GHz. Accordingly, the AP MLD may recognize the bands in which STA1-1 can operate and may allocate one of the links to STA1-1 based on the capabilities of the AP MLD and STA1-1.

In some embodiments, the AP MLD may request link information from a STA. In some embodiments, the AP MLD may transmit a link information request frame to a STA.

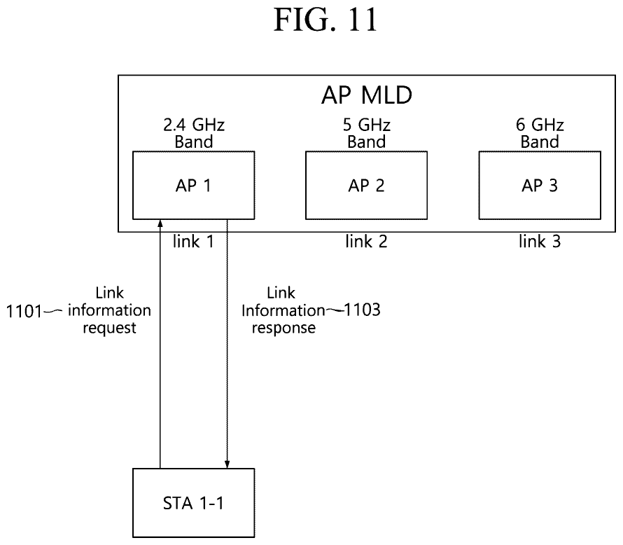

FIG. 11 illustrates an example exchange of link information by a link information request frame and a link information response frame in accordance with an embodiment. In some embodiments, the link information request frame and the link information response frame may be a MAC frame, which can be newly defined. As illustrated in FIGS. 11, AP1, AP2 and AP3 are affiliated with AP MLD. AP1 is associated with STA1-1 on link 1 and operates on a 2.4 GHz band. AP2 operates on link 2 at 5 GHz band. AP3 operates on link 3 at 6 GHz band. AP1 transmits a link information request frame 1101 to STA1-1 on link 1. The link information request frame 1101 may request the SINR and/or buffer status of STA1-1. In some embodiments, the information request frame 1101 may request other network and/or operational characteristics of the STA and/or the one or more links on which the STA is operating.

Upon receiving the link information request frame 1101, the STA1-1 may transmit the requested information to AP1 of the AP MLD. In some embodiments, the STA may transmit a link information response frame 1103 that includes the SINR and/or buffer status information to the AP MLD. In some embodiments, the link information response frame 1103 may include one or more fields indicating the measured SINR value and the amount of traffic accumulated in the buffer. In some embodiments, the SINR information may provide an average value of SINR measured during communication with the AP MLD. In some embodiments, the buffer information may provide an amount of traffic currently accumulated in a buffer of the STA1-1.

In some embodiments, a STA may periodically provide the AP MLD with link operational status information, such as the measured SINR value and/or the amount of traffic accumulated in the buffer while exchanging frames with AP MLD. The frequency by which the STA provides the operational status information can be configured (e.g., frequent, less frequent, among others) based on the network conditions of the BSS.

In some embodiments, in response to a request from the AP MLD, the STA can transmit link status information while sending an acknowledgement (ACK) frame, a Block Ack (BA) frame, among various other types of frames, to the AP MLD.

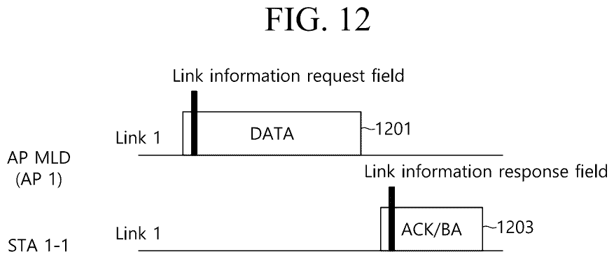

FIG. 12 illustrates exchanging link information during data transmission in accordance with an embodiment. In particular, FIG. 12 illustrates AP1 affiliated with AP MLD operating on link 1 and STA1-1 also operating on link 1. AP1 transmits data 1201 that includes one or more control fields. In particular, the data 1201 may include a link information request field. The link information request field may request the SINR and/or buffer status of the responder STA1-1. Accordingly, STA1-1 transmits an ACK or BA frame 1203 that includes a link information response field. The link information response field may include information about the average value of SINR measured during communication with the AP MLD and the amount of traffic currently accumulated in the buffer of STA1-1. In some embodiments, the link formation request field and the link information response field may be a control field. In some implementations, the link formation request field and the link information response field may be a subfield of HT (high throughput) control field or QoS control field.

In some embodiments, a STA and AP MLD may include link information in a control frame, such as a request to send (RTS) frame or clear to send (CTS) frame so that the AP MLD can obtain the link information of the STA.

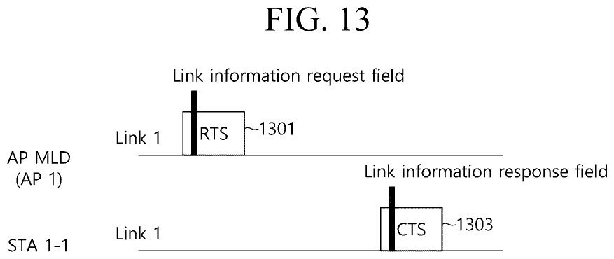

FIG. 13 illustrates communicating link information in a RTC frame and a CTS frame in accordance with an embodiment. As illustrated, AP1 is affiliated with AP MLD and operates on link 1. STA1-1 operates on link 1. AP1 transmits an RTS frame 1301 that includes a link information request field. STA1-1 transmits a CTS frame 1303 that includes a link information response field. As illustrated, the link formation request field and the link information response field may be included in control frames, such as the RTS frame and the CTS frame.

In some embodiments, the AP MLD may determine a link allocation for one or more links that improves the transmission rates and/or stabilizes the network based on link information obtained from one or more STAs (e.g., all STAs) and for one or more links (e.g., link 1, link 2, and link 3, among others). In some embodiments, the parameters used for link allocation may be the SINR and/or buffer status, among other parameters and operational characteristics, of one or more STAs on one or more links within a network.

In some embodiments, a STA with a low SINR can be allocated to a different better link that provides an improved SINR, thereby improving the transmission rate of the link. In some embodiments, load balancing may be achieved by allocating STAs from a link that may be suffering delays due to a large amount of accumulated traffic in the buffer of the STAs to a different link that is not experiencing heavy traffic.

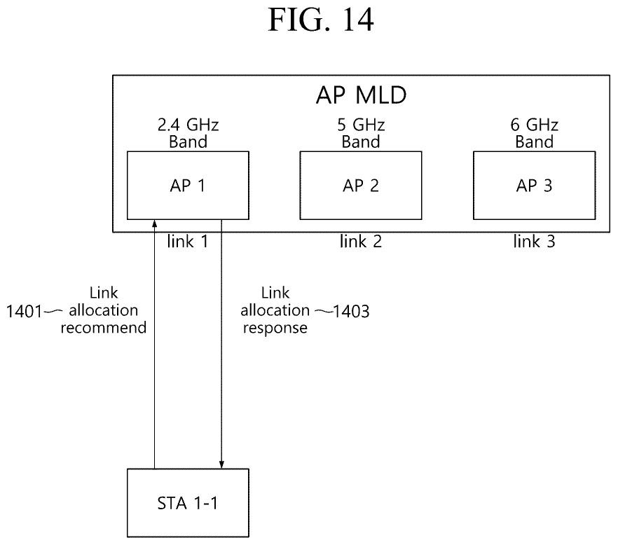

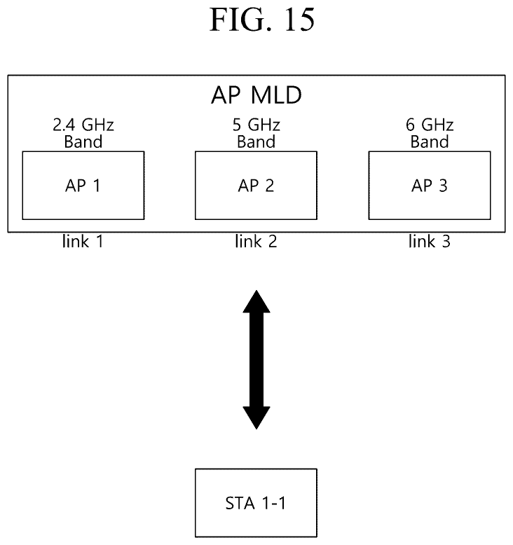

FIG. 14 illustrates an AP MLD providing a link allocation recommendation to a STA in accordance with an embodiment. As illustrated, AP1, AP2 and AP3 are affiliated with AP MLD. AP1 is associated with STA1-1 on link 1. AP2 operates on link 2 at 5 GHz band. AP3 operates on link 3 at 6 GHz. AP1 transmits a link allocation recommendation frame 1401 to STA1-1. The link allocation recommendation frame 1401 may recommend, for example, link 2 for STA1-1. STA 1-1 transmits a link allocation response frame 1403 to AP1. STA1-1 may accept or reject the AP MLD's recommendation through the link allocation response frame 1403. If STA1-1 agrees to the recommended link allocation, the STA1-1 may operate on the recommended link (e.g., link 2) as shown in FIG. 15 in accordance with an embodiment. In particular, FIG. 15 illustrates STA1-1 now operating on link 2 with AP2.

In some embodiments, a STA may be the target of a link allocation. In particular, the STA may try to establish a new association with an AP MLD, and thus become the target of a link allocation. In some embodiments, the STA may be a STA in a power saving (PS) mode and may become a target of a link allocation.

In some embodiments, for a STA who tries to establish a new association with AP MLD, the AP MLD may recommend the STA to operate on a currently least crowded link. In some embodiments, for a STA in PS mode, when the STA receives a Beacon frame, the Beacon frame may include a recommendation of a least crowded link on which the STA should operate.

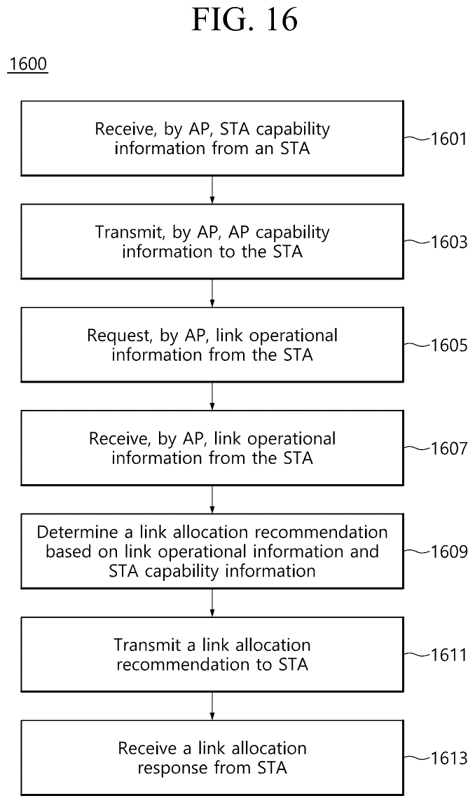

FIG. 16 illustrates a flow chart of an example process of an AP providing a link configuration recommendation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 16 illustrates operations performed in an AP MLD, such as AP MLD illustrated in FIG. 8. The process 1600 begins in operation 1601.

In operation 1601, the AP receives capability information from a STA. In some embodiments, the STA may provide information regarding the operating bands (e.g., 2.4 GHz, 5 GHz, or 6 GHz, among others) supported by the STA. In some embodiments, the capability information may be provided in any of a variety of types of frames, including an association request frame, a probe request frame, and/or other management frames.

In operation 1603, the AP transmits capability information to the STA. In some embodiments, the AP may provide information regarding the links and bands supported by the AP MLD (e.g., link 1 for 2.4 GHz, link 2 for 5 GHz, or link 3 for 6 GHZ, among others). In some embodiments, the AP capability information may be provided in any of a variety of types of frames, including an association response frame, a probe response frame, and/or other management frames.

In operation 1605, the AP requests link operational information from the STA. In some embodiments, the AP may transmit a link information request frame to the STA. The link information request frame may include an indicator that requests the SINR and/or buffer status information of the STA. In some embodiments, the link information request may be transmitted within a data transmission to the STA. In some embodiments, the link information may be requested in an RTS frame.

In operation 1607, the AP receives link operational information from the STA. In some embodiments, the link operational information may be received in a link information response frame. In some embodiments, the link information response frame may include a field indicating a measured SINR and an amount of traffic accumulated in a buffer. In some embodiments, the link operational information may include an average value of SINR measured during communication with the AP MLD and an amount of traffic currently accumulated in a buffer of the STA. In some embodiments, the AP may receive frequent link operational information from the STA, which may be transmitted in an ACK or Block Ack frame from the STA. In some embodiments, the AP may receive a CTS frame that includes the link operational information.

In operation 1609, the AP determines a link allocation recommendation based on the link operational information and the STA capability information. In some embodiments, the AP performs link allocation to improve the transmission rate and stabilize the network based on link information of one or more STAs (e.g., all STAs) operating on one or more links. In some embodiments, the parameters used for the link allocation may be the SINR and buffer status of each STA. In particular, STAs with a low SINR may be allocated to other better links based on prospective SINR, which may improve the transmission rate of one or more links. In some embodiments, load balancing may be achieved by allocating STAs from a current link that are suffering delays due to large traffic accumulated in the buffer of the STAs to other links that have less accumulated traffic. In some embodiments, if a STA is physically located far from the AP or located at a coverage edge, the STA may have a low SINR with a high probability of transmission failure and thus may be allocated to a different link.

In operation 1611, the AP transmits a link allocation recommendation to the STA. In some embodiments, the AP may transmit a link allocation recommendation frame to the STA. The link allocation recommendation may recommend a different link on which the STA should operate.

In operation 1613, the AP receives a link allocation response from the STA. In some embodiments, the AP may receive a link allocation response frame from the STA. The STA may indicate that it accepts or rejects the AP MLDs recommendation in the link allocation response frame. If the STA accepts the recommendation, the AP MLD and the STA may begin to operate on the newly recommended link.

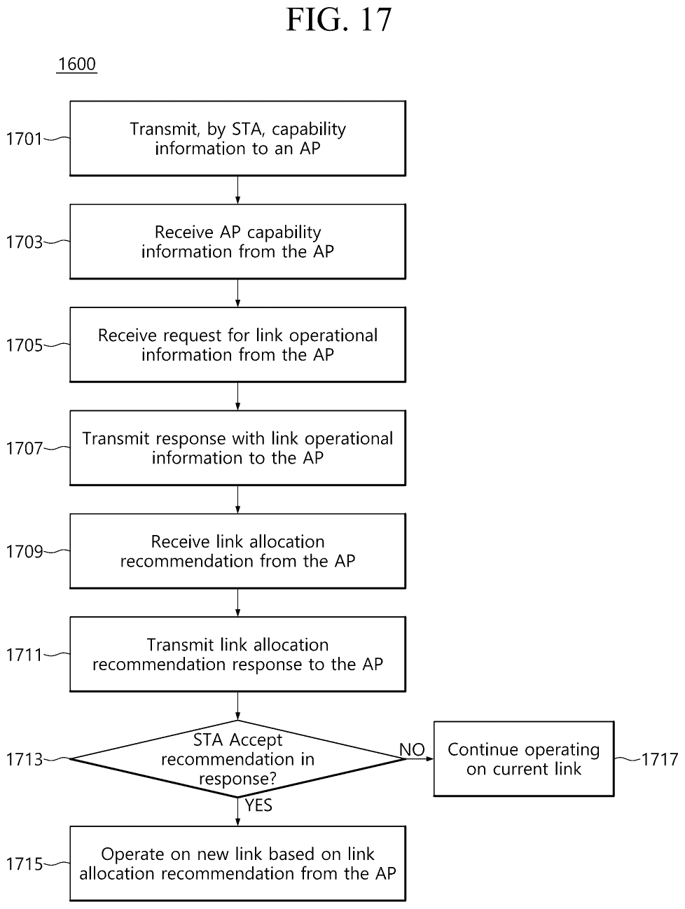

FIG. 17 illustrates a flow chart of an example process, by a STA, of configuring links based on a link allocation recommendation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in a non-AP STA, such as non-AP STA illustrated in FIG. 8.

The process 1700 begins in operation 1701.

In operation 1701, the STA transmits capability information to an AP. In some embodiments, the STA may provide information regarding the operating bands (e.g., 2.4 GHz, 5 GHz, or 6 GHz, among others) supported by the STA. In some embodiments, the capability information may be provided in any of a variety of types of frames, including an association request frame, a probe request frame, and/or other management frames.

In operation 1703, the STA receives AP capability information from the AP. In some embodiments, the AP may provide information regarding the links and bands supported by the AP MLD (e.g., link 1 for 2.4 GHz, link 2 for 5 GHz, or link 3 for 6 GHZ, among others). In some embodiments, the AP capability information may be provided in any of a variety of types of frames, including an association response frame, a probe response frame, and/or other management frames.

In operation 1705, the STA receives a request for link operational information from the AP. In some embodiments, the STA may receive a link information request frame from the AP. The link information request frame may include an indicator that requests the SINR and/or buffer status information of the STA. In some embodiments, the link information request may be received within a data transmission from the AP. In some embodiments, the link information may be requested in an RTS frame received from the AP.

In operation 1707, the STA transmits a response with link operational information to the AP. In some embodiments, the link operational information may be transmitted in a link information response frame. In some embodiments, the link information response frame may include a field indicating a measured SINR and an amount of traffic accumulated in a buffer. In some embodiments, the link operational information may include an average value of SINR measured during communication with the AP MLD and an amount of traffic currently accumulated in a buffer of the STA. In some embodiments, the STA may transmit frequent link operational information to the AP, which may be transmitted in an ACK or Block Ack frame from the STA. In some embodiments, the STA may transmit a CTS frame to the AP that includes the link operational information.

In operation 1709, the STA receives a link allocation recommendation from the AP. In some embodiments, the STA may receive a link allocation recommendation frame from the AP. The link allocation recommendation may recommend a different link on which the STA should operate.

In operation 1711, the STA transmits a link allocation recommendation response to the AP. In some embodiments, the STA may transmit a link allocation response frame to the AP. The STA may indicate that it accepts or rejects the AP MLDs recommendation in the link allocation response frame.

In operation 1713, if the STA accepts the recommendation in the link allocation recommendation response, the process proceeds to operation 1715.

In operation 1715, the STA operates on the new link recommended based on the link allocation recommendation from the AP.

In operation 1713, if the STA does not accept the recommendation in the link allocation recommendation response, the process proceeds to operation 1717.

In operation 1717, the STA continues to operate on the current link on which it has been operating.

To illustrate the interchangeability of hardware and software, items such as the various illustrative blocks, modules, components, methods, operations, instructions, and algorithms have been described generally in terms of their functionality. Whether such functionality is implemented as hardware or software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of”' does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) multi-link device (MLD) for facilitating wireless communication in a wireless network, the AP MLD device comprising processing circuitry configured to:
transmit, to a station (STA) affiliated with a non-AP MLD, a first frame that includes a request for operational information from the STA, wherein the STA is operating on a first link;
receive, from the STA, a second frame that includes a response to the request for the operational information;
determine to allocate a second link to STA based on the response to the request for the operational information; and
transmit, to the STA, a third frame that includes a link allocation recommendation that allocates the second link to the STA.

2. The AP MLD of claim 1, wherein the response to the request for the operational information indicates that:
a number of STAs operating on the first link are larger than a first threshold;
an amount of traffic accumulated in a buffer of an STA among one or more STAs operating on the first link is larger than a second threshold; or
the STA is located near a coverage edge or has a signal-to-noise ratio below a third threshold.

3. The AP MLD of claim 1, wherein:
the request for the operational information is included in a medium access control (MAC) frame of the first frame; and
the response to the request for operational information is included in a MAC frame of the second frame.

4. The AP MLD of claim 1, wherein:
the request for the operational information is included in a control field of the first frame; and
the response to the request for the operational information is included in a control field of the second frame.

5. The AP MLD of claim 1, wherein:
the first frame is a request to send (RTS) frame that includes the request for the operational information; and
the second frame is a clear to send (CTS) frame that includes the response to the request for the operational information.

6. The AP MLD of claim 1, wherein the processing circuitry is further configured to:
receive a fourth frame from the STA that includes capability information associated with links or operating bands supported by the STA; and
determine the link allocation recommendation based on the capability information.

7. The AP MLD of claim 1, wherein the second frame includes a signal to interference and noise ratio (SINR) or a buffer status of the STA.

8. A station (STA) associated with a non-access point (AP) multi-link device (MLD) for connecting to a wireless network, comprising processing circuitry configured to:
receive, from a first AP affiliated with an AP MLD, a first frame that includes a request for operational information, wherein the STA is operating on a first link;
transmit, to the first AP, a second frame that includes a response to the request for the operational information;
receive, from the first AP, a third frame that includes a link allocation recommendation that allocates a second link to the STA, wherein a second AP affiliated with the AP MLD operates on the second link; and
initiate communication with the second AP on the second link based on the link allocation recommendation.

9. The STA of claim 8, wherein the response to the request for the operational information indicates that:
a number of STAs operating on the first link are larger than a first threshold;
an amount of traffic accumulated in a buffer of an STA among one or more STAs operating on the first link is larger than a second threshold; or
the STA is located near a coverage edge or has a signal-to-noise ratio below a third threshold.

10. The STA of claim 8, wherein:
the request for the operational information is included in a medium access control (MAC) frame of the first frame; and
the response to the request for the operational information is included in a MAC frame of the second frame.

11. The STA of claim 8, wherein:
the request for the operational information is included in a control field of the first frame; and
the response to the request for the operational information is included in a control field of the second frame.

12. The STA of claim 8, wherein:
the first frame is a request to send (RTS) frame that includes the request for the operational information; and
the second frame is a clear to send (CTS) frame that includes the response to the request for the operational information.

13. The STA of claim 8, wherein the processing circuitry is further configured to:
transmit, to the first AP, a fourth frame that includes capability information.

14. The STA of claim 8, wherein the second frame includes a signal to interference and noise ratio (SINR) or a buffer status of the STA.

15. A computer-implemented method by an access point (AP) multi-link device (MLD) for facilitating wireless communication in a wireless network by, the method comprising:
transmitting, to a station (STA) affiliated with a non-AP MLD, a first frame that includes a request for operational information from the STA, wherein the STA is operating on a first link;
receiving, from the STA, a second frame that includes a response to the request for the operational information;
determining to allocate a second link to STA based on the response to the request for the operational information; and
transmitting, to the STA, a third frame that includes a link allocation recommendation that allocates the second link to the STA.

16. The computer-implemented method of claim 15, wherein the operational information indicates that:
a number of STAs operating on the first link are larger than a first threshold;
an amount of traffic accumulated in a buffer of an STA among one or more STAs operating on the first link is larger than a second threshold; or
the STA is located near a coverage edge or has a signal-to-noise ratio below a third threshold.

17. The computer-implemented method of claim 15, wherein:
the request for the operational information is included in a medium access control (MAC) frame of the first frame; and
the response to the request for the operational information is included in a MAC frame of the second frame.

18. The computer-implemented method of claim 15, wherein:
the request for the operational information is included in a control field of the first frame; and
the response to the request for the operational information is included in a control field of the second frame.

19. The computer-implemented method of claim 15, wherein:
the first frame is a request to send (RTS) frame that includes the request for the operational information; and
the second frame is a clear to send (CTS) frame that includes the response to the request for the operational information.

20. The computer-implemented method of claim 15, further comprising:
receiving a fourth frame that includes capability information from the STA; and
determining the link allocation recommendation based on the capability information.
